(19) United States
(12) Patent Application Publication
(10) Pub. No.: US 2021/0038934 A1
(43) Pub. Date: Feb. 11, 2021

(54) CONVENIENT FIRE FIGHTING UNIT

(71) Applicant: Asiasun Pump Valve Co., Ltd., Taizhou (CN)

(72) Inventors: Lei CHANG, Taizhou (CN); Xiping CHENG, Taizhou (CN); Fabin CHEN, Taizhou (CN); Kai WANG, Taizhou (CN); Enbin CHEN, Taizhou (CN); Yi PAN, Taizhou (CN)

(21) Appl. No.: 16/890,130

(22) Filed: Jun. 2, 2020

(30) Foreign Application Priority Data
Aug. 6, 2019 (CN) 201910719315. 4

(51) Int. Cl. A62C 27/00; B66F 9/065

(52) U.S. Cl. CPC A62C 27/00; B66F 9/065

(57) ABSTRACT

The present invention relates to a convenient fire fighting unit. The convenient fire fighting unit comprises a pick-up and a hand-lifting pump supported on an electric barrow; a lifting base fixed onto a cargo floor; each of the two sides of the lifting base is provided with a rear support seat, an intermediate support seat and a front hinged seat from the inside to the outside; the rear support seat is hinged with the rear end of a hydraulic cylinder; the intermediate support seat is hinged with the rear end of an intermediate connecting rod; the front hinged seat is hinged with the rear end of a front connecting rod; the electric barrow is provided on the lifting support plate; and the hydraulic cylinder is connected with a hydraulic assembly provided in the cargo box or on the lifting base.

### CROSS REFERENCE TO RELATED APPLICATION

This application is related to and claims the benefit of Chinese Patent Application Number 201910719315.4 filed on Aug. 6, 2019, the entire contents of which are incorporated herein by reference in their entirety.

### TECHNICAL FIELD

The present invention relates to a fire fighting device, in particular to a convenient fire fighting unit.

### BACKGROUND

At present, the hand-lifting pumps equipped by fire rescue departments across the country are relatively heavy, with an average weight of about 166 kg. They are usually placed on small vehicles or fire-fighting trucks. It takes 4 people to remove the hand-lifting pumps from the vehicles and lift them to the use site. After the use of the hand-lifting pumps is completed, it is laborious and time-consuming to install the hand-lifting pumps on the vehicle, and the intensity of fire fighting operations is high, which is not conducive to rapid response operations of fire fighting.

### SUMMARY

The present invention provides a convenient fire fighting unit, which is simple in structure and convenient to use, time-saving and labor-saving to remove and install the hand-lifting pump respectively from and onto a fire-fighting truck, so that fast fire fighting is facilitated.

The technical scheme adopted by the present invention is: a convenient fire fighting unit, comprising a pick-up and a hand-lifting pump supported on an electric barrow, wherein a lifting base fixed onto a cargo floor through bolts is provided in a cargo box at the rear part of the pick-up; each of the two sides of the lifting base is provided with a rear support seat, an intermediate support seat and a front hinged seat from the inside to the outside; the rear support seat is hinged with the rear end of a hydraulic cylinder; the intermediate support seat is hinged with the rear end of an intermediate connecting rod; the front hinged seat is hinged with the rear end of a front connecting rod; the front end of the hydraulic cylinder is connected with the middle part of the front connecting rod through a rotary drive seat; the front end of the front connecting rod and the front end of the intermediate connecting rod are correspondingly hinged with the upper part of a front vertical rod and the upper part of a rear vertical rod; the lower part of the front vertical rod and the lower part of the rear vertical rod are fixedly connected with the middle part and the rear part of a lifting support plate; the electric barrow is provided on the lifting support plate; and the hydraulic cylinder is connected with a hydraulic assembly provided in the cargo box or on the lifting base.

Further, the front end of the lifting support plate is provided with a guiding slope.

Further, the lifting support plate is provided with anti-skid patterns.

Further, a fire warning light is provided on the pickup.

Further, a water suction hose rack is provided on the roof of the pickup and/or the top of the cargo box.

Further, a fire hose box is provided in the cargo box.

Further, the roller of the electric barrow is provided with a braking device.

Further, the cargo box has a roof structure or a roofless structure.

Further, the rear of the lifting support plate is provided with an arc-shaped groove corresponding to the roller of the electric barrow.

Further, there is an available hydraulic assembly and a standby hydraulic assembly.

According to the weight and volume of the hand-lifting pump, the present invention adopts an electric barrow to support the hand-lifting pump, and the walking speed of the barrow can be adjusted according to road conditions. The hand-lifting pump and the electric barrow can be locked and fixed or separated. When loading and unloading the hand-lifting pump on the electric barrow, the stability of the hand-lifting pump during loading and unloading is taken into account to prevent rollover or forward slip. According to the weight and volume of the hand-lifting pump and the barrow, the hydraulic cylinder sends out or pulls to retract the front connecting rod. The front connecting rod drives the intermediate connecting rod through the front vertical rod, the lifting support plate and the rear vertical rod to synchronously send or pull to retract with the front connecting rod, and sends the lifting support plate from the cargo box to the ground to facilitate the electric barrow to movably support the hand-lifting pump on the lifting support plate. Alternatively, the electric barrow is retracted into the cargo box, and the lifting support plate is always kept horizontal. An arc-shaped groove with an arc of one third of the circumference of the front wheel of the electric barrow is provided at the rear of the lifting support plate. The front roller of the electric barrow and the arc-shaped groove are automatically positioned. The brake device of the electric barrow brakes, and the electric barrow is stable on the lifting support plate. In order to ensure the normal operation of the lifting operation, the hydraulic assembly is designed as a dual-hydraulic system, with one hydraulic assembly being available and one hydraulic assembly being standby, which is free to switch.

Combined with the structure of the fire-fighting truck, an ND80 hose sorting rack and a joint storage box are designed and manufactured according to the two sides of the front of the pickup cargo box, which are mainly used to store ND80 hoses, hose joints and other vehicle accessory equipment. The DN100 suction hose used by the hand-lifting pump is relatively long and cannot be folded and stored. A U-shaped groove and a support frame are designed and manufactured at the roof of the pickup and/or above the cargo box, which are mainly used to place the suction hose. This type of structure is similar to the existing fire-fighting truck structure.

The present invention can be operated by an individual to realize the loading and unloading of the hand-lifting pump from the lifting support plate, and it is stable in operation, safe and reliable. The hand-lifting pump and the electric barrow are operated by an individual, and the individual can walk on different road conditions such as unsurfaced roads, farmland reclamation, grassland, up and down slopes, etc. Water hoses, soft hoses, water distributors and other fire-fighting appliances supporting the hand-lifting pump, which are accessory, form an independent fighting unit to improve fire-fighting and fire-extinguishing capabilities; a small pickup type is selected, which is strong in passing ability and adaptable to various complex road conditions.

### BRIEF DESCRIPTION OF THE DRAWINGS

FIG. 1 is a schematic diagram of the structure of a electric barrow being unloaded according to the present invention.

In the drawing: a pickup 1, a fire warning light 2, a suction hose rack 3, a topless cargo box 4, a fire hose box 5, a lifting base 6, a rear support seat 7, a middle support seat 8, a front hinged seat 9, a rotary drive seat 10, a hydraulic assembly 11, a hydraulic cylinder 12, an intermediate connecting rod 13, a front connecting rod 14, a front vertical rod 15, a rear vertical rod 16, a lifting support plate 17, an arc-shaped groove 18, an electric barrow 19, a roller 20, a hand-lifting pump 21.

### DESCRIPTION OF THE EMBODIMENTS

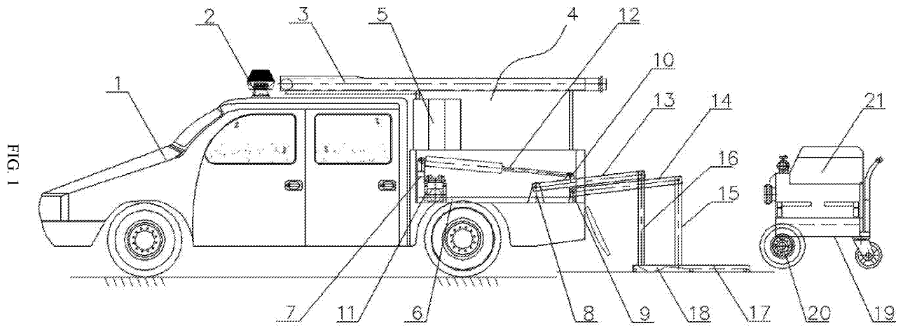

The following is a further description with reference to the drawings and embodiments. As shown in FIG. 1: A convenient fire fighting unit comprises a pickup 1, a fire warning light 2, a suction hose rack 3, a topless cargo box 4, a fire hose box 5, a lifting base 6, a rear support seat 7, a middle support seat 8, a front hinged seat 9, a rotary drive seat 10, a hydraulic assembly 11, a hydraulic cylinder 12, an intermediate connecting rod 13, a front connecting rod 14, a front vertical rod 15, a rear vertical rod 16, a lifting support plate 17, an arc-shaped groove 18, an electric barrow 19, a roller 20, and a hand-lifting pump 21.

A fire warning light 2 is provided on the pickup 1, a water suction hose rack 3 is provided on the roof of the pickup 1 and/or the top of the topless cargo box 4, and a fire hose box 5 is provided in the topless cargo box 4. A lifting base 6 fixed onto a cargo floor through bolts is provided in the topless cargo box 4 at the rear part of the pick-up 1; each of the two sides of the lifting base 6 is provided with a rear support seat 7, an intermediate support seat 8 and a front hinged seat 9 from the inside to the outside; the rear support seat 7 is hinged with the rear end of a hydraulic cylinder 12; the hydraulic cylinder 12 is connected with a hydraulic assembly 11 provided on the bottom plate of the topless cargo box 4, the intermediate support seat 8 is hinged with the rear end of the intermediate connecting rod 13; the front hinged seat 9 is hinged with the rear end of the front connecting rod 14; the front end of the hydraulic cylinder 12 is connected with the middle part of the front connecting rod 14 through a rotary drive seat 10; the front end of the front connecting rod 14 and the front end of the intermediate connecting rod 13 are correspondingly hinged with the upper part of a front vertical rod 15 and the upper part of a rear vertical rod 16; the lower part of the front vertical rod and the lower part of the rear vertical rod are fixedly connected with the middle part and the rear part of a lifting support plate 17; the electric barrow 19 can be pushed on the lifting support plate 17; and the rear of the lifting support plate is provided with an arc-shaped groove 18 corresponding to the roller 20 of the electric barrow 19.

Based on the above embodiment, the front end of the lifting support plate may be provided with a guiding slope. The lifting support plate may be provided with anti-skid patterns.

Based on the above embodiment, there is an available hydraulic assembly and a standby hydraulic assembly.

What is claimed is:

1. A convenient fire fighting unit, comprising a pick-up and a hand-lifting pump supported on an electric barrow, wherein a lifting base fixed onto a cargo floor through bolts is provided in a cargo box at the rear part of the pick-up; each of the two sides of the lifting base is provided with a rear support seat, an intermediate support seat and a front hinged seat from the inside to the outside; the rear support seat is hinged with the rear end of a hydraulic cylinder; the intermediate support seat is hinged with the rear end of an intermediate connecting rod; the front hinged seat is hinged with the rear end of a front connecting rod; the front end of the hydraulic cylinder is connected with the middle part of the front connecting rod through a rotary drive seat; the front end of the front connecting rod and the front end of the intermediate connecting rod are correspondingly hinged with the upper part of a front vertical rod and the upper part of a rear vertical rod; the lower part of the front vertical rod and the lower part of the rear vertical rod are fixedly connected with the middle part and the rear part of a lifting support plate; the electric barrow is provided on the lifting support plate; and the hydraulic cylinder is connected with a hydraulic assembly provided in the cargo box or on the lifting base.

2. The convenient fire fighting unit according to claim 1, wherein the front end of the lifting support plate is provided with a guiding slope.

3. The convenient fire fighting unit according to claim 1, wherein the lifting support plate is provided with anti-skid patterns.

4. The convenient fire fighting unit according to claim 1, wherein a fire warning light is provided on the pickup.

5. The convenient fire fighting unit according to claim 1, wherein a water suction hose rack is provided on the roof of the pickup and/or the top of the cargo box.

6. The convenient fire fighting unit according to claim 1, wherein a fire hose box is provided in the cargo box.

7. The convenient fire fighting unit according to claim 1, wherein the roller of the electric barrow is provided with a braking device.

8. The convenient fire fighting unit according to claim 1, wherein the cargo box has a roof structure or a roofless structure.

9. The convenient fire fighting unit according to claim 1, wherein the rear of the lifting support plate is provided with an arc-shaped groove corresponding to the roller of the electric barrow.

10. The convenient fire fighting unit according to claim 1, wherein there is an available hydraulic assembly and a standby hydraulic assembly.
